(19) United States
(12) Patent Application Publication
(10) Pub. No.: US 2021/0157408 A1
(43) Pub. Date: May 27, 2021

(54) SYSTEMS AND METHODS FOR MULTI-DIRECTIONAL HAPTIC EFFECTS

(71) Applicant: Immersion Corporation, San Jose, CA (US)

(72) Inventors: Peyman Karimi Eskandary, Montreal (CA); Vahid Khoshkava, Laval (CA); Jamal Saboune, Montreal (CA); Simon Forest, Montreal (CA)

(73) Assignee: Immersion Corporation, San Jose, CA (US)

(21) Appl. No.: 16/698,597

(22) Filed: Nov. 27, 2019

(51) Int. Cl. G06F 3/01; G06F 3/0488; G06F 3/041

(52) U.S. Cl. CPC G06F 3/016; G06F 3/0418; G06F 3/04883

(57) ABSTRACT

Systems and methods for multi-directional haptic effects for haptic surfaces are disclosed. One exemplary system includes one or more resonant actuators coupled to a surface, the one or more resonant actuators configured to generate a haptic effect comprising vibrations in a plurality of nonparallel directions, the haptic effect configured to displace the surface, and the vibrations being within a two-dimensional plane that is substantially parallel to the surface; a processor in communication with the one or more resonant actuators; and a non-transitory computer-readable medium comprising instructions that are executable by the processor to cause the processor to: detect an event; generate at least one haptic drive signal based on the event; and transmit the at least one haptic drive signal to the one or more resonant actuators, the one or more resonant actuators further configured to receive the at least one haptic drive signal and responsively output the haptic effect.

### TECHNICAL FIELD

The present disclosure relates generally to haptic effects. More specifically, but not by way of limitation, the present disclosure relates to providing multi-directional haptic effects to surfaces.

### BACKGROUND

Haptically-enabled devices and environments have become increasingly popular. Such devices and environments provide a more immersive user experience. Many modern user interface devices provide haptic feedback as the user interacts with the device. Haptic feedback can provide an enhanced user experience with a variety of immersive interactions and a sense of realism to a user.

### SUMMARY

Various embodiments of the present disclosure provide multi-directional haptic effects for haptic surfaces. One example system includes one or more resonant actuators coupled to a surface, the one or more resonant actuators configured to generate a haptic effect comprising vibrations in a plurality of nonparallel directions, the haptic effect configured to displace the surface, and the vibrations being within a two-dimensional plane that is substantially parallel to the surface; a processor in communication with the one or more resonant actuators; and a non-transitory computer-readable medium comprising instructions that are executable by the processor to cause the processor to: detect an event; generate at least one haptic drive signal based on the event; and transmit the at least one haptic drive signal to the one or more resonant actuators, the one or more resonant actuators further configured to receive the at least one haptic drive signal and responsively output the haptic effect.

One example method includes detecting, by a processor, an event; generating, by the processor, at least one haptic drive signal based on the event; and transmitting, by the processor, the haptic drive signal to one or more resonant actuators, the one or more resonant actuators configured to receive the at least one haptic drive signal and responsively output a haptic effect comprising vibrations in a plurality of nonparallel directions, the haptic effect configured to displace the surface, and the vibrations being within a two-dimensional plane that is substantially parallel to a surface.

These illustrative examples are mentioned not to limit or define the scope of this disclosure, but rather to provide examples to aid understanding thereof. Illustrative examples are discussed in the Detailed Description, which provides further description. Advantages offered by various examples may be further understood by examining this specification.

### BRIEF DESCRIPTION OF THE DRAWINGS

The accompanying drawings, which are incorporated into and constitute a part of this specification, illustrate one or more certain examples and, together with the description of the examples, serve to explain the principles and implementations of the certain examples.

FIG. 1 shows an example of a system for multi-directional haptic effects.

FIG. 2 shows another example of a system for multi-directional haptic effects.

FIG. 3 shows another example of a system for multi-directional haptic effects.

FIG. 4 shows yet another example of a system for multi-directional haptic effects.

FIG. 5 shows a plot of acceleration measured at a surface that represents a multi-directional haptic effect.

FIG. 6 shows another plot of acceleration measured at a surface that represents a multi-directional haptic effect.

FIG. 7 shows examples of systems for multi-directional haptic effects.

FIG. 8 shows other examples of systems for multi-directional haptic effects.

FIG. 9 shows an example computing device suitable for use with example systems for multi-directional haptic effects.

FIG. 10 shows an example method for providing multi-directional haptic effects.

### DETAILED DESCRIPTION

Certain aspects and features of the present disclosure involve a system capable of providing multi-directional haptic effects at a surface with which a user is in contact. The system can provide the multi-directional haptic effects, for example, by selectively actuating linear resonant actuators (LRAs) coupled to the surface with different orientations (e.g., angled) relative to one another.

Providing multi-directional haptic effects across a surface may allow a user to feel more consistent haptic effects. For example, if the surface is a planar surface, then a user that is in contact with the surface may perceive sensations that are substantially similar in strength or magnitude, irrespective of a directionality of movement associated with the contact. These multi-directional haptic effects may have substantially equal amounts of vibrational force throughout the duration of such a movement. As a result, the multi-directional haptic effects may allow a user to have a more enjoyable user experience by perceiving consistent haptic effects regardless of a directionality of a user's movement.

Multi-directional haptic effects may also enable the user to more readily perceive haptic effects in settings where it might otherwise be challenging. For instance, a user that is in a vehicle in motion, may desire to contact a surface of a computing device (e.g., a touch screen of a navigation system). Ordinarily, bumps and turns may result in a user's finger sliding in a variety of directions along the surface, inhibiting the user's ability to perceive certain other types of haptic effects that may lack strength and/or consistency.

In addition, some haptic output devices may be configured to produce stronger haptic effects in a particular planar direction with respect to another planar direction. For example, a planar directional movement associated with a less efficient, motorized haptic output device, e.g., an eccentric rotating mass (ERM), may reduce an ability to control a haptic effect (e.g., vibrations) due to unequal weight distribution, delayed response times, or weaker haptic effects at lower frequencies. And a computing device may be required to adjust a magnitude of a haptic effect to compensate for such a configuration. However, the multi-directional haptic effects described herein may provide consistent haptic effects in substantially all planar directions of a surface and for the entire duration of the haptic effect. This may enable the computing device to forgo the extra computations and processing power typically required to compensate for the above-mentioned configurations of haptic output devices. Additional advantages offered by various examples may be further understood by examining this specification.

### Illustrative Example

One illustrative example of the present disclosure includes a haptically-enabled home appliance, such as a refrigerator, microwave, stove, or laundry machine. The home appliance includes a touch screen that can detect contacts and transmit sensor signals associated with the contacts to an internal processing device.

One or more actuators can be coupled to the surface for providing multi-directional haptic effects. For example, a curved resonant actuator (CRA) can be coupled to the surface. One such CRA includes a mass and a guide, where the guide defines a curved path along which the mass can move (e.g., reciprocate in a substantially back-and-forth motion along a length of the actuator) to produce a haptic effect that propagates in multiple directions along a surface substantially simultaneously. A user may perceive the haptic effect generated by the CRA as a multi-directional haptic effect output to the surface. Other examples of the actuator can include two or more CRAs or two or more linear resonant actuators (LRAs) coupled to the touch screen in different orientations with respect to each other. These may also provide multi-directional haptic effects, as described in greater detail with respect to the figures below.

The one or more actuators may be selectively controllable separately from the touch screen by a computing device. The computing device may be part of the home appliance or remote from the home appliance. Either way, the computing device can detect a user interaction with the touch screen and operate the one or more actuators to generate one or more multi-directional haptic effects based on the user interaction.

For example, a home appliance can use the computing device to operate the one or more actuators in response to a user interaction with a graphical user interface (GUI), such as a menu or button, output on the touch screen. The user interaction may include a button press, a virtual button press, or dragging a virtual slider in the GUI. The home appliance may determine that the user interaction is a request to perform a task (e.g., adjust a temperature setting or dispense ice) using the home appliance. In response, the home appliance may cause the one or more actuators to generate a multi-directional vibration while the user is contacting the touch screen. The user may perceive the multi-directional vibration at the surface of the touch screen as a multi-directional haptic effect. Further, in some examples, the multi-directional vibration may be configured to provide the user with information, such as confirmation of the button press.

In addition, the home appliance may operate two or more CRAs or two or more LRAs in sequence or in concert to generate haptic effects. For example, the home appliance may cause the two LRAs to vibrate simultaneously. In another example, the home appliance may apply a time delay (e.g., a phase shift) to a haptic drive signal applied to one of the two LRAs to provide more consistent haptic feedback across the surface. By controlling a time delay (e.g., a phase shift) and/or an amplitude of the haptic drive signals applied to the two LRAs, the directional components of vibration experienced by the surface can be controlled (e.g., selected or adjusted). In other words, the orientation of one or more lines of displacement of the surface can be modified. More specifically, by controlling the time delay (e.g., phase shift) of the haptic drive signals, a path followed by the center of gravity of the mass of the surface may be adjusted or modified. For example, at a 90 degree phase shift, the path may be circular, whereas at a 45 degree phase shift, the path may be elliptical. By controlling the amplitude of the haptic drive signals, the force components of the vibrational movement of the surface 102 are adjusted, such that the resultant angle of displacement is changed.

The home appliance may adjust, modify, or otherwise change a perceptible sensation produced by the multi-directional haptic effect by using a time delay, an adjusted amplitude of a haptic drive signal, or a combination of these. The home appliance may also monitor the output of a haptic effect while the haptic effect is ongoing and alter one or more of the haptic drive signals (e.g., in real time) to ensure the fidelity of the haptic effect throughout its duration.

The description of the illustrative example above is provided merely as an example, not to limit or define the limits of the present subject matter. Various other examples are described herein and variations of such examples would be understood by one of skill in the art. Advantages offered by various examples may be further understood by examining this specification and/or by practicing one or more examples of the claimed subject matter.

### Illustrative Systems and Methods for Multi-Directional Haptic Effects

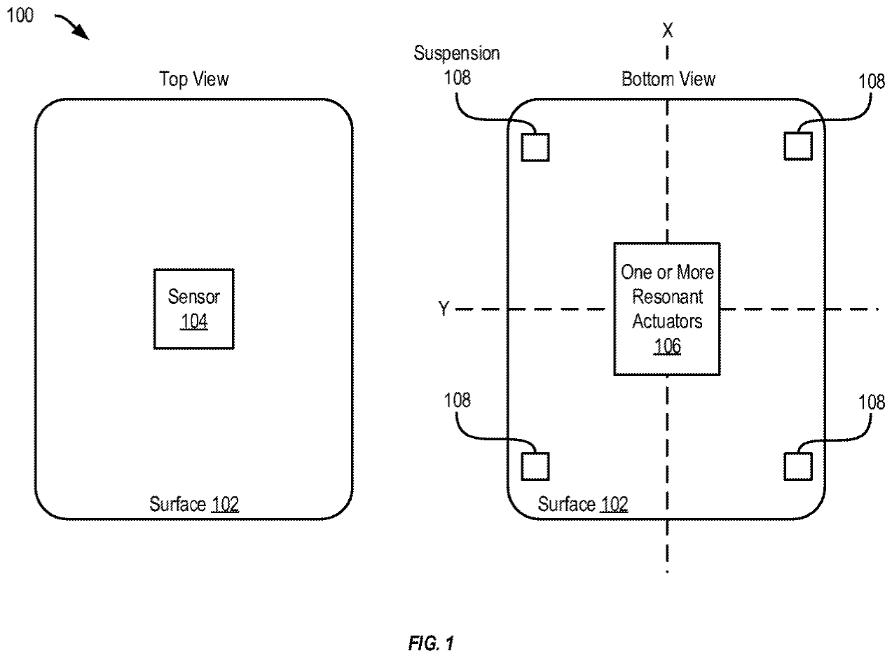

FIG. 1 shows a block diagram of a system 100 for multi-directional haptic effects. In the example shown in FIG. 1, the example system 100 includes a sensor 104 (e.g., a touch sensor, pressure sensor, proximity sensor, capacitive sensor, or resistive sensor, among other possibilities) that is configured to detect an event such as a user interaction with a surface 102. The sensor 104 may transmit a sensor signal associated with the event or user interaction to a computing device that includes a processor. The sensor 104 may be any of the types of sensors discussed herein. For example, the sensor 104 may include a touch sensor configured to detect a contact at the surface 102 and transmit a sensor signal indicating one or more characteristics of the contact to a processor. The sensor signal can indicate the presence or absence of the user interaction; the location of the user interaction; a change in location, path, velocity, acceleration, pressure, or other characteristic of a user interaction over time; or other location data associated with user interaction. Further, in some examples, the surface 102 is a multi-touch surface that reports location data associated with multiple contact locations to the computing device.

The system 100 may also include the computing device mentioned above. The computing device may store and/or execute program code for determining a haptic effect. For example, the computing device can detect an event such as a user interacting with the surface 102 in response to the sensor 104 transmitting a sensor signal to the computing device. The computing device can receive the sensor signal. The computing device may determine a haptic effect (e.g., a multi-directional haptic effect) based on the sensor signal. In some examples, the computing device may determine the haptic effect based on sensor data within in the sensor signal or the event itself. For instance, the computing device may determine that sensor data included in the sensor signal indicates a location, velocity, acceleration, pressure, and/or other aspect of the user interaction. The computing device may determine the haptic effect based on the sensor data, user interaction, or a type of the user interaction. The computing device may generate and transmit a haptic signal (e.g., a haptic drive signal) based on the haptic effect.

Additionally or alternatively, the sensor 104 can include one or more sensors for detecting one or more characteristics of a haptic effect propagating through the surface 102. For example, the one or more sensors 104 may include an accelerometer, a microphone, a motion sensor, a gyroscope, a pressure sensor, a piezo sensor (e.g., a piezoelectric sensor, a piezoresistive sensor, or a piezo-ceramic sensor), a s-beam load cell, a strain gauge, a capacitive device, a force transducer, a force-sensing resistor, a combination of these, or any other suitable sensor. In one example, the sensor 104 can include a first sensor configured to detect one or more events such as user interactions as discussed above and one or more second sensors configured to detect one or more characteristics of the haptic effect.

For example, the second sensor(s) can be used to monitor/measure a haptic effect output to the surface 102 in two or more nonparallel or substantially perpendicular directions. The second sensor(s) can then transmit sensor signals to a controller, such as a closed-loop controller. The controller may be the same as or separate from a processor of the system 100. The controller can receive the sensor signals at a particular sample rate. The controller may use sensor data, derived from the sensor signals, and responsively adjust a characteristic of a haptic drive signal being applied to one or more resonant actuators 106 (e.g., a resonant actuator, such as a CRA or LRA), in order to adjust a characteristic of the haptic effect (e.g., magnitude, frequency, duration). This creates a feedback loop through which the control device can control the haptic effect perceived by the user, e.g., to ensure that it remains substantially consistent despite changes in environmental conditions.

In one example, the controller may be configured to adjust a haptic drive signal in order to decrease a duration of a haptic effect, and thereby reduce haptic confusion caused by haptic effects that are output in close proximity in time or with some amount of overlap. In another example, the controller may adjust or modify a phase shift of the same haptic drive signal to ensure two or more resonant actuators 106 operate in concert, enabling the one or more haptic effects produced by the two or more resonant actuators 106 to provide a multi-directional haptic effect.

For example, the controller may modify the haptic drive signal to ensure the efficacy of a perceptible haptic effect as being multi-directional or omnidirectional. In some examples, the controller may compare sensor data to a predetermined acceptable range of values to determine a particular characteristic of the haptic effect to modify. In another example, the controller may use the predetermined acceptable range to determine an adjustment to be applied to the haptic drive signal based on a desired intensity level of a haptic effect. In such an example, the controller may adjust the characteristic of the haptic effect until the controller receives sensor data that satisfies the predetermined acceptable range. In some examples, the controller may adjust one or more characteristics of a haptic effect substantially in real time.

The system 100 also includes one or more resonant actuators 106 that are coupled to the surface 102. The one or more resonant actuators 106 may be configured to output the haptic effect (e.g., a multi-directional haptic effect) at the surface 102. In one example, the one or more resonant actuators 106 may output a multi-directional haptic effect by generating vibrational movements in a plurality of nonparallel directions. A vibrational movement is a periodic motion in a specific direction and along a surface that produces one or more primary force vectors in the specific direction. The one or more resonant actuators 106 can produce the vibrational movements in a plurality of nonparallel directions within a plane (e.g., a two-dimensional plane). These vibrational movements may be produced within a two-dimensional plane that is substantially parallel to the surface 102. In some examples, a vibrational movement may correspond to a line of motion or displacement of the surface 102. And in some examples, the vibrational movement may represent one or more degrees of freedom of the one or more resonant actuators 106.

In some examples, a multi-directional haptic effect may be an omnidirectional haptic effect. An omnidirectional haptic effect propagates radially and outwardly in some or all directions along a surface from an originating location and has a substantially equal magnitude in all propagating directions for at least a predefined distance from the originating location. In some examples, an omnidirectional haptic effect may propagate radially and outwardly in a sequential manner, while in other examples, an omnidirectional haptic effect may be propagate smoothly and continuously in a radial and outward manner. The ability to provide haptic effects that are substantially the same magnitude in multiple directions along a surface may provide a user with more reliable, consistent, and realistic haptic feedback in a variety of circumstances (e.g., while a finger slides across the surface 102 in different directions, such as side-to-side, up-and-down, in a circular motion, a gestural motion, etc.), resulting in a more immersive and enjoyable user experience.

The one or more resonant actuators 106 may include one actuator or multiple actuators, each of which is a resonant actuator (e.g., an LRA or a CRA). For example, the one or more resonant actuators 106 may be a single CRA, two or more CRAs, two or more LRAs, and/or another type of resonant actuator (e.g., a resonant piezoelectric actuator). The one or more resonant actuators 106 may include additional parts, such as one or more masses, springs, coils, motors, wiring components, magnets, covers, coupling mechanisms, adhesives, mechanical parts, circuit components, PCBs, integrated circuits (ICs), or any combination of these.

A resonant actuator is an actuator that has a mass that moves within a housing in response to forces applied to the mass. In one example, a resonant actuator may apply an electromagnetic force to the mass. In such an example, the mass may include a number of magnetic materials, such as ferromagnetic materials (e.g., permanent magnets such as rare earth metals, iron, cobalt, nickel, alloys or compounds of these, ferrites, etc.), ferrimagnetic materials (e.g., materials with opposing but unequal amounts of ions such as Fe²⁺ or Fe³⁺), or any number of materials that produce an electromagnetic field.

A resonant actuator can also be actuated by transmitting an electrical signal (e.g., a haptic drive signal) to the resonant actuator. The electrical signal can be configured to oscillate the mass at a resonant frequency associated with the resonant actuator (e.g., a harmonic frequency that is an integer multiple of the fundamental frequency of the mass). In response to receiving the electrical signal, the resonant actuator can apply an electromagnetic force that causes the mass to move in a back-and-forth, reciprocating motion. The movement of the mass, reciprocating between endpoints of the resonant actuator, causes a bidirectional displacement of the resonant actuator as a whole. And when coupled to a surface, this bidirectional displacement may be felt by a user as a perceptible vibration.

In some examples, a coil or spring may be used to keep the mass in a substantially central location while the resonant actuator is at a rest. And in some examples, the resonant frequency may be produced by a voice coil (e.g., a magnetic, circular collar or winding that is excitable to produce electromagnetic waves in response to an applied electrical signal). Further, in some examples, a directionality of a corresponding movement of the mass may be determined by a polarity of an alternating current (AC) associated with an electrical signal that is applied to the voice coil. In other examples, a characteristic of a haptic effect may be determined based on a corresponding characteristic of the electrical signal, such as an amplitude, frequency, duration, periodicity, or any combination of these, which can be controlled separately and independently by a processor.

In some examples, the surface 102 may be a touch-sensitive surface (e.g., a touch pad), touch screen (e.g., a touch-sensitive display screen), non-display surface, and/or non-touch-sensitive surface. And in some examples, surface 102 may be a surface in a vehicle (e.g., a dashboard, center console, steering wheel, infotainment system, HVAC controls, radio controls, etc.), a kitchen appliance, another type of appliance, a desk or chair, a table, a tablet, a laptop, a mousepad, or any other suitable touch surface.

In this example, the surface 102 rests atop of suspension 108, which may be coupled to (e.g., affixed to or contained within) the surface 102 by a clamping device, e.g., an adhesive device or any other suitable device. Further, the suspension 108 includes a substantially flat surface that may couple the surface 102 to a support structure. In this example, suspension 108 is shown as four protrusions coupling the surface 102 to the support structure. However, in some examples, suspension 108 may be coupled to any number of locations of the surface 102. Further, the suspension 108 may be made of any suitable material such as silicon, a polymer, an elastomer, paraffin wax, etc. In some examples, the suspension 108 may be made of a suitable rigid material, e.g., steel, carbon fiber, a composite fiber, a suitable polymer, etc.

The surface 102 can be affixed to a support surface, such as a printed circuit board (PCB) or housing of a computing device. The surface 102 may be affixed using any suitable coupling mechanism, such as a suspension (e.g., suspension 108), by one or more clamps, screws, by an adhesive (e.g., a pressure-sensitive adhesive, an epoxy, an extension of the housing, etc.), or another suitable mechanism.

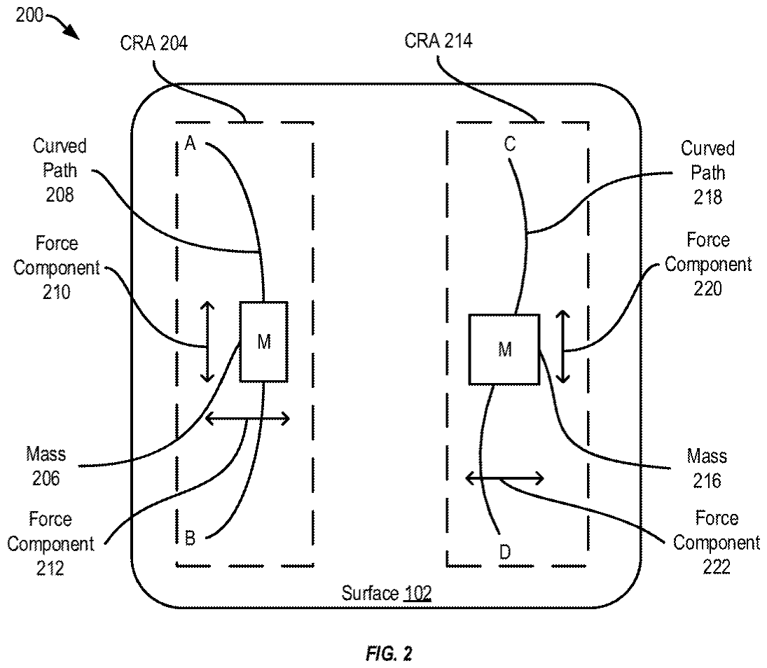

It should be appreciated that the system 100 may be implemented using any number or types of resonant actuators (e.g., in contact with or proximate to one or more edges, sides quadrants, etc. of the surface 102). For example, the system 100 can be implemented using a curved resonant actuator (CRA), as further described in detail below with respect to the system 200 of FIG. 2.

FIG. 2 shows a block diagram of one example system 200 for multi-directional haptic effects. The system 200 includes two examples of CRAs, 204 and 214, coupled to the surface 102. Although two CRAs 204 and 214, are shown as being coupled to surface 102, it is to be understood that only one CRA, either 204 or 214, could be coupled to surface 102 in order to provide a multi-directional haptic effect as described below.

The CRA 204 includes a mass 206. Mass 206 is configured to move along a curved path 208 between points A and B. A curved path is a nonlinear path that extends between two non-overlapping endpoints (e.g., it does not form a closed loop). In some examples, the mass 206 is configured to move along a guide that defines the curved path 208. In some examples, the guide may be a mechanical guide such as a rail, level arm, support, enclosure, or another mechanical structure. The CRA 204 may propel the mass 206 along the guide or curved path 208 by applying an electromagnetic force, another type of force, or a physical phenomenon to the mass 206. In response to such a force being applied to the mass 206, the mass 206 moves between points A and B in a reciprocal, back-and-forth motion, thereby generating a vibrational movement. A reaction of the force applied to the mass 206, following the curved path 208, creates both Y force components 210 and X force components 212.

In this example, the mass 206 of CRA 204 is depicted as being in a location that corresponds substantially to a vertex around an axis of symmetry of the curved path 208. By enabling the mass 206 to travel a vertical distance and a horizontal distance along a substantially symmetrical curved path 208, the CRA 204 can produce haptic effects with Y force components 210 and X force components 212 in a two-dimensional plane that is parallel to a surface 102 coupled to the CRA 204.

In some examples, a computing device may transmit an electrical signal (e.g., a haptic drive signal) to the CRA 204 that causes the mass 206 to move back-and-forth along the curved path 208. And in some examples, the haptic drive signal may be configured to cause the mass 206 to move along the curved path 208 at a resonant frequency associated with the CRA 204 (e.g., 150 Hz, 175 Hz, 200 Hz, or any other resonant frequency), thereby generating vibrations at the resonant frequency. In other examples, the haptic drive signal may be configured to cause the mass 206 to move along the curved path 208 at a resonant frequency of the mass 206 itself. In some examples, the haptic drive signals may accelerate the mass 206 by applying a voltage to generate an electrical force. As the mass 206 moves along the curved path 208, the movement of the mass 206 causes the CRA 204 to generate vibrational movements in multiple nonparallel directions within a plane so as to create the Y force components 210 and X force components 212, which may collectively produce a multi-directional or an omnidirectional haptic effect.

In one example, the CRA 204 may be mounted beneath the surface 102, and the actuation of the CRA 204 may result in forces (e.g., vibrational movements) along the curved path 208. And these forces may be perceptible in multiple propagation directions that are nonparallel (e.g., perpendicular) to a straight line between the points A and B of the curved path 208. In some examples, an omnidirectional haptic effect may provide one or more forces having substantially similar magnitudes along some or all of those propagation directions. And in some examples, the curvature of the curved path 208 can dictate the amount of perceptible force perceived in some or all of the propagation directions.

In some examples, the curved path 208 may deviate minimally from a straight line between the two points (e.g., a visually-perceptible macrobend or a visually-imperceptible microbend). This minimal deviation may result in a moderate amount of force being output in directions that are nonparallel to a straight line between the two points. In an alternative example, the CRA 204 may include a guide rail that defines a curved path between the two points, where the curved path is an arc (e.g., a portion of a circumference of a circle or other substantial curvature). Such an arc may deviate significantly from a straight line between the two points. As a result, movement of the mass 206 along the arc may generate a haptic effect with a significantly greater amount of force in the nonparallel directions than is present in the prior example, resulting in stronger haptic effects than a curved path 208 of a similar length that includes a macrobend.

In some examples, a radius of the curved path 208 may be increased such that CRA 204 is configured to produce haptic effects with greater intensity in nonparallel directions. An amount of curvature in the curved path 208 may dictate (e.g., be proportional to) the strength and intensity of a haptic effect output by the CRA 204 in the nonparallel directions, whereby an increase in the radius of the curvature of the arc may result in an increase in the amount of force output in the nonparallel directions. An appropriate amount of curvature in the curved path 208, e.g., to produce a desired haptic effect, may be determined based on a mathematical function (e.g., a circular, elliptical, parabolic, hyperbolic, polynomial, sigmoid, logistic, Gompertz, Smoothstep, Gudermannian, logarithmic, or sinusoidal function).

In some examples, the CRA 204 may include a housing. The housing of CRA 204 may dictate an amount of curvature of the curved path 208. A size-constrained CRA 204, having such a housing, may include a curved path 204 that may be designed by a virtual model that employs curve fitting to constrain an amount of curvature implemented with respect to the linear relationship between points A and B. For instance, the amount of curvature can be determined based on respective distances between points A and B along axes that are substantially parallel to force components 210 (e.g., a Y distance) and 212 (e.g., a X distance) such that the curved path 208 fits within the overall footprint of the housing of the CRA 204.

In some examples, the curved path 208 may have a sinusoidal shape with two, three, four, or any suitable number of vertices. And in some examples, the curved path 204 may include two or more curvatures having inflection points that correspond to the same direction or opposing directions. Further, in some examples, the curved path 204 may include an arcuate section (e.g., an arced portion of the curved path) that is less than an entire length of the curved path 208. And while the CRA 204 of FIG. 2 depicts a curved path 208 with an arc shape, in other examples the CRA 204 can have curved paths with other types of shapes.

One such example of a CRA with multiple vertices is CRA 214, which is also shown in FIG. 2. As shown, CRA 214 includes a mass 216 that is configured to move along a curved path 218 between points C and D. The curved path 218 still extends between points C and D, though the curved path 218 now includes two vertices and has a substantially sinusoidal shape. The mass 216 also moves between points C and D in a reciprocal, back-and-forth motion in order to produce to force components 220 and 222 (e.g., vibrational movements) that are substantially similar to force components 210 and 212, respectively. But in this example, the mass 216 is depicted as being in a location that corresponds substantially to an inflection point (e.g., a bisector) of the curved path 218 between two diametrically opposed curvatures. As the mass 216 travels along the curved path 218, the CRA 214 produces haptic effects with force components 220 and 222.

The CRA 214 may include all of the features CRA 204 and operate substantially similarly to CRA 204. But in this example, the CRA 214 includes the curved path 218 having two curvatures having vertices that correspond to vertically opposite angles, and each of the curvatures are a substantially uniform length. The curved path 218 may be configured such that a first portion of the curved path 218 includes a curvature in a first direction, and a second portion of the curved path 218 includes a curvature in a second direction that is opposite to the first direction.

In some examples, the curved path 218 may be equally bisected such that the two opposing curvatures are equidistant with respect to a midpoint along the curved pathway, like an “S” shape. This may advantageously provide consistent haptic effects along the substantially symmetrical and congruent path for the mass 216 to travel. For instance, the movement of the mass 216 along a symmetrical and smooth curve may allow the CRA 214 to produce intense haptic effects that are equally distributed in directions that are nonparallel to those substantially aligned with a straight line between points C and D. The haptic effect that is produced by such a movement may be multi-directional, whereby the mass 216 moves in a plurality of directions, causing vibrational movements that substantially similar in intensity in both spatial dimensions at the same time.

Further, these multi-directional haptic effects may include forces that are substantially stronger and more consistently felt throughout a coupled surface (e.g., surface 102). When coupled to such a surface 102, a user may perceive a multi-dimensional vibration that is substantially similar in intensity in all propagation directions along the surface 102. These intense vibrations may also be perceived as occurring at the same time and throughout a duration of the haptic effect. Of course, other examples of the CRA 214 can include curved paths 218 having any number and configuration of curvatures, such as three or more curvatures.

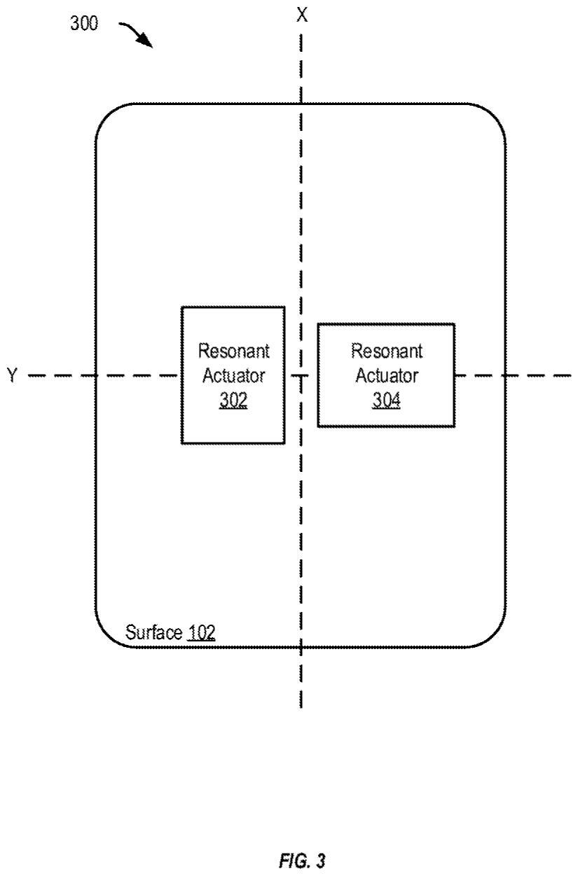

While the resonant actuators (e.g., CRAs 204, 212) of FIG. 2 are shown as being parallel to one another, in other examples the resonant actuators can have other configurations. One example of another configuration of resonant actuators is described below with reference to FIG. 3.

FIG. 3 shows another example of a system 300 for multi-directional haptic effects. FIG. 3 depicts a bottom view of the system 300 that includes two resonant actuators 302, 304 coupled to the surface 102 in different orientations with respect to one another, such that the vibrational movement provided by each of the resonant actuators 302, 304 to the surface 102 is in different non-parallel directions. In the non-limiting embodiment shown, the resonant actuators 302, 304 are positioned substantially perpendicular to one another, although the resonant actuators 302, 304 can be positioned in any other suitable other location, configurations, or spatial arrangements. Resonant actuators 302, 304 may include any of the types of actuators discussed herein. For example, they may be CRAs (having any of the features discussed above), LRAs, resonant piezos, or a combination thereof.

The resonant actuators 302, 304 may be separately controllable (e.g., separately and independently controllable) by a processor. For example, the processor can transmit separate and/or different haptic drive signals to each of the resonant actuators 302, 304. In some examples, the haptic drive signal can be substantially similar to one another. For instance, the haptic drive signals can have with a time delay relative to the other (e.g., a clocked signal). In another example, two haptic drive signals can be substantially similar to one another, but one of the two haptic drive signals can be a phase-shifted version of the other haptic drive signal. In one non-limiting example, one of the haptic drive signals may have a 90 degree phase shift, relative to the other haptic drive signal.

In this example, the 90 degree phase shift (e.g., one quarter of a cycle) of two haptic drive signals enables tandem operation by creating a circular motion (e.g., a substantially omnidirectional motion). For example, the surface 102 translates a vibrational movement of the substantially omnidirectional motion in a manner that displaces a center of mass of the surface 102 to follow a circular path, thereby creating the circular motion. In one example, the computing device may generate and transmit substantially identical haptic drive signals to resonant actuators 302, 304, where one of the haptic drive signals has a 90 degree phase shift relative to the other. Such phase-shifted haptic drive signals produce a multi-directional haptic effect in a substantially circular path. This tandem operation can create perceptible multi-directional haptic effects (e.g., vibrotactile effects) at the surface 102.

The consistency of the amplitude of the multi-directional haptic effect may ensure a desired strength of the haptic feedback is perceptibly, substantially the same in all directions along the surface 102. For example, the consistency of the amplitude of the haptic effect may ensure a desired strength of the haptic feedback is perceptibly substantially the same for the two LRAs as it would be for a single LRA. Applying the haptic drive signal with the 90 degree phase shift yields a perceptible two-dimensional vibration that is substantially similar in intensity in all propagation directions in the two-dimensional plane of the surface 102 at the same time.

In one example, a magnitude of the acceleration caused by the vibrations remains constant for the two LRAs due to the 90 degree phase shift of one of the haptic drive signals. Further, by applying the haptic drive signal with the 90 degree phase shift, the real world effect of this constant magnitude of acceleration may be realized in the production of a multi-directional haptic effect that includes a perceptible, multi-dimensional vibration that is substantially similar in intensity in multiple spatial dimensions of the surface 102 at the same time.

For example, resonant actuators 302, 304 may include a first LRA and a second LRA. In such an example, the first LRA may be configured to produce a first force in a first direction, while the second LRA may be configured to produce a second force in a second direction that is substantially perpendicular to the first direction. Further, in response to phase-shifted haptic drive signals, combined forces of the first and the second LRAs may produce a vector-summed force in an angular direction that is substantially in between the first and second directions (e.g., an acute angular direction, a mitre angular direction, or a substantially resultant vector direction). By controlling the phase-shift and/or an amplitude of the haptic drive signals, the path of a displace of the center of mass of the surface 102 can be adjusted. Thus, one or more directional force components of the multi-directional haptic effect can be controlled (e.g., selected, adjusted, modified, etc.) using the time delay to modify a displacement of the surface 102. More specifically, by controlling the time delay (e.g., phase shift) of the haptic drive signals, a path followed by the center of gravity of the mass of the surface 102 may be adjusted or modified. For example, at a 90 degree phase shift, the path may be circular, whereas at a 45 degree phase shift, the path may be elliptical. By controlling the amplitude of the haptic drive signals, the force components of the vibrational movement of the surface 102 are adjusted, such that the resultant angle of displacement is changed.

For example, an orientation (e.g., angular direction) of a force vector of displacement at the surface 102 may be controlled using a time delay of the haptic drive signals applied to resonant actuators 302, 304. The orientation of such a force vector may be adjusted by altering the timing of one or more directional force components associated with a path corresponding to the displacement of a center of gravity of the mass of the surface 102. In one example, applying haptic drive signals to resonant actuators 302, 304, with the 90 degree phase shift discussed above, may cause a haptic effect to be output to the surface 102 along a substantially circular path. In another example, applying haptic drive signals to resonant actuators 302, 304 that include a 45 degree phase shift may cause a haptic effect to be output to the surface 102 along a substantially elliptical path.

In some examples, the computing device may adjust an amplitude of a haptic drive signal applied to the resonant actuators 302, 304 to provide more consistent haptic feedback across the surface 102. The computing device may control the amplitude of the haptic drive signals modify one or more directional force components of the multi-directional haptic effect. By adjusting the amplitude of the haptic drive signals, the computing device can change an orientation of one or more vibrational movements associated with the displacement of the surface 102 by modifying the one or more directional force components.

For example, the orientation of a force vector of the displacement can be controlled by adjusting an amplitude of one or more of the haptic drive signals. In one example, resonant actuators 302, 304 may include a first LRA and a second LRA. In this example, increasing an amplitude of a first haptic drive signal that is applied to the first LRA may change increase a directional force component output by the first LRA. Such an increase in the directional force component output by the first LRA may cause a directionality of a resultant force vector of displacement to be biased. For example, a combined, resultant force vector of displacement output by the first LRA and the second LRA may have a greater perceptible strength or magnitude at the surface 102 along a direction that is substantially parallel to the directional force component associated with the first LRA. This biased, resultant force vector of displacement of the surface 102 may be perceived by a user in contact with the surface 102 as being stronger, more consistent, or more intense along the directionality of the resultant force vector.

In some examples, the computing device may adjust, modify, or otherwise change a perceptible sensation produced by the multi-directional haptic effect by using a time delay and/or adjusting an amplitude of a haptic drive signal. Such multi-directional haptic effects may be experienced by the user in contact with the surface 102, regardless of a directionality of movement associated with the contact.

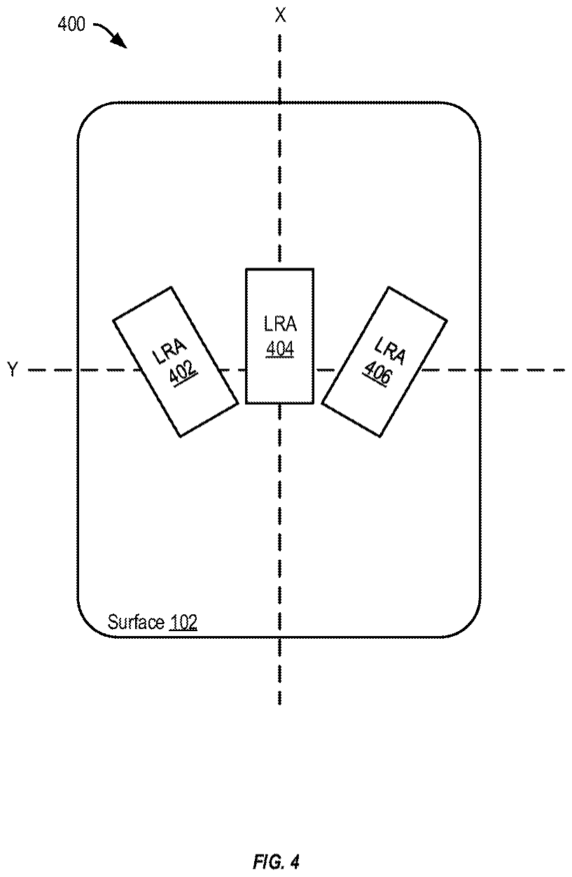

FIG. 4 shows yet another example of a system 400 for multi-directional haptic effects. The system 400 includes three actuators—LRAs 402, 404, and 406 that are coupled to surface 102. Actuators 402-406 are shown as LRAs in FIG. 4, although in other examples, LRAs 402-406 may be replaced with any number of or types of actuators discussed herein.

The LRAs 402-406 may be positioned such that each of the three LRAs 402-406 is substantially evenly-spaced from each other. In addition, the three LRAs 402-406 are positionally-orientated with an angular offset (e.g., having a different orientation with respect to one another and/or substantially nonparallel positioning) that is substantially equiangular. For example, the LRAs 402-406 are each angularly offset from one another at approximately 60 degrees, which may increase perceptible forces during a haptic effect by providing a full range of directional motions with respect to a substantially semi-circular arrangement of LRAs.

In one example, each of the three LRAs 402-406 may receive a 60 degree phase-shifted version of the same haptic drive signal that causes each actuator to output a haptic effect every sixth of a cycle, which is collectively perceptible as a multi-directional haptic effect. For example, a communicatively coupled computing device may generate and transmit substantially identical haptic drive signals to LRAs 402-406 with 60 degree phase shifts, producing a multi-directional haptic effect in a substantially circular path (e.g., a substantially omnidirectional motion).

In some examples, four actuators may be oriented with 45 degree offsets to one another. Each of the four actuators may be actuated every eighth of a cycle by supplying the four actuators with haptic drive signals having 45 degree phase shifts to one another, to collectively generate a haptic effect. In other examples, six LRAs may be oriented with 30 degree offsets to one another. Each of the six actuators may be actuated every twelfth of a cycle by supplying the six actuators with haptic drive signals having 30 degree phase shifts to one another, to collectively generate a haptic effect.

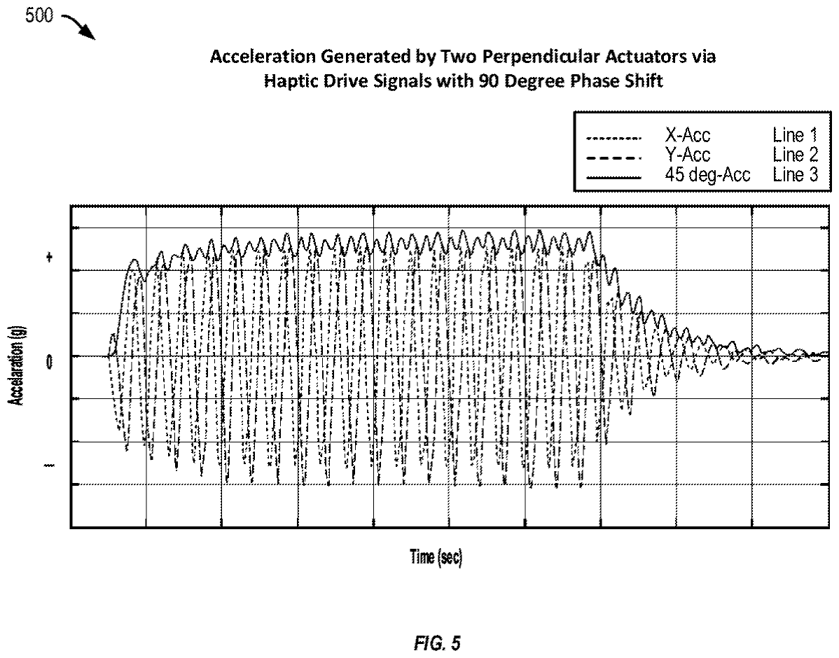

FIG. 5 shows a plot 500 of acceleration measurements taken at a surface that represents an omnidirectional haptic effect. Specifically, the plot 500 shows the acceleration measurements corresponding to an omnidirectional haptic effect propagating through the surface (e.g., surface 102). More specifically, the plot 800 shows acceleration measurements taken by a sensor (e.g., sensor 104) at the surface over time. The acceleration measurements were obtained during the actuation of two resonant actuators with a substantially perpendicular orientation according to the techniques discussed herein. The two resonant actuators were configured to generate vibrotactile haptic effects using substantially the same haptic drive signals (e.g., having the same frequency, magnitude, wave shape, etc.). And one of the two resonant actuators received a 90 degree phase-shifted version of the haptic drive signal that was provided to the other resonant actuator. An amount of acceleration, measured in units of gravitational acceleration (e.g., g or g-force is approximately 9.8 m/s), is plotted on the y-axis of the graph and time measured in seconds is plotted on the x-axis of the graph.

The plot 500 shown in FIG. 5 includes line 1 (X-Acc) represents a substantially sinusoidal measured acceleration along a X-axis of the surface, and line 2 (Y-Acc) represents a substantially sinusoidal measured acceleration along a Y-axis of the surface. The combined output of the two actuators with a 90 degree phase shift results in a vibrotactile haptic effect having a magnitude of acceleration that is illustrated by line 3 (Acc-Magnitude). The plot 500 shows that two perpendicular actuators, driven by 90 degree phase-shifted haptic drive signals, may produce an omnidirectional haptic effect. In this example, the omnidirectional haptic effect may be a vibrotactile haptic effect that propagates in substantially perpendicular directions with consistent acceleration that is sustained over a period of time.

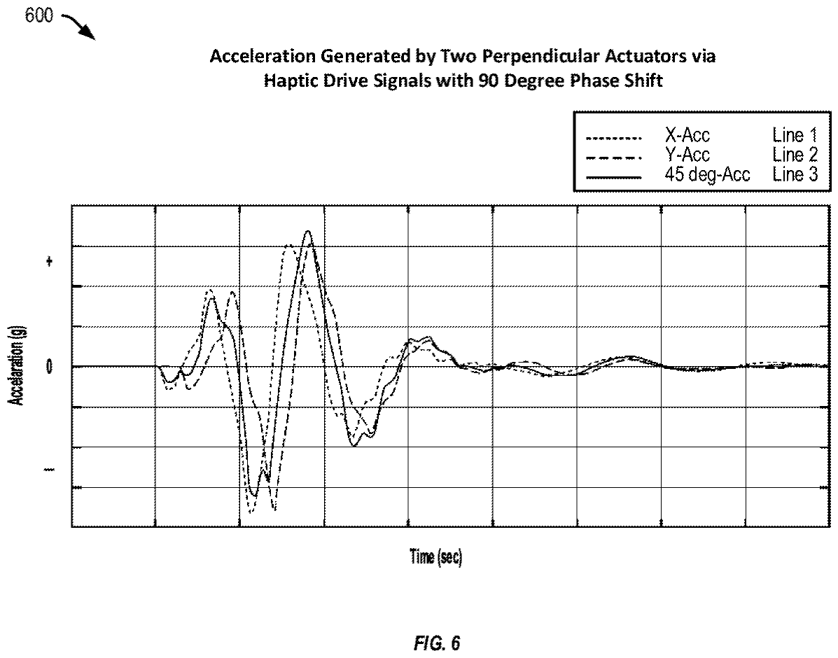

FIG. 6 shows another plot 600 of acceleration measurements taken at a surface that represents an omnidirectional haptic effect. Specifically, the plot 600 shows the acceleration measurements corresponding to an omnidirectional haptic effect propagating through a surface (e.g., surface 102). The plot 600 shows acceleration measured by a sensor (e.g., sensor 104) at the surface over time. Measurements were obtained for plot 600 in a similar manner as discussed above for plot 500. Two actuators positioned substantially-perpendicularly generated vibrotactile haptic effects in response to 90 degree phase-shifted versions of a haptic drive signal. Plot 600 shows gravitational acceleration plotted on the Y-axis of the graph and time measured in seconds plotted on the X-axis.

The plot 600 shown in FIG. 6 includes line 1 (X-Acc) having a substantially sinusoidal, measured acceleration along a X-axis of the surface and line 2 (Y-Acc) representing a substantially sinusoidal, measured acceleration along a Y-axis of the surface. The combined output of the two actuators (due to the 90 degree phase-shifted haptic control signals) results in a vibrotactile haptic effect having a magnitude of acceleration that is illustrated by line 3 (45 deg-Acc). As can be seen from the plot 600, the vibrotactile haptic effect is different from the one discussed above with respect to FIG. 5.

For example, the vibrotactile haptic effect shown in plot 600 may provide a haptic effect that includes three bursts at a particular frequency, which are represented by the measured acceleration of the haptic effect shown in FIG. 6. In plot 600, the acceleration is measured along a direction offset at approximately 45 degrees and in between substantially perpendicular forces produced by the two substantially perpendicular actuators (e.g., force components 210 and 212 of FIG. 2).

As shown in plot 600, acceleration in the 45 degree direction substantially tracks acceleration along the X and Y axes of the surface, indicating that the haptic effect has a substantially consistent magnitude in the X direction, the Y direction, and a 45 degree angle there-between. Though, in some cases constructive interference results in the acceleration in the 45 degree direction exceeding the accelerations in the other two directions. For example, line 3 includes a peak that exceeds both of the measured accelerations X-Acc and Y-Acc. This is due to a summation of the force components corresponding to the X-Acc and Y-Acc, resulting in a combined, resultant force vector that exceeds a magnitude of either of the force components individually. And the resultant force vector may include one or more residual force components (e.g., reverberations and/or forces caused by previous vibrations provided to the surface) that corresponding to the measurement taken in the 45 deg-Acc direction. In some examples, repetitive haptic effects may feel perceptibly stronger to a user in contact with a surface at a 45 degree angular offset because the residual force components act as additional vectors added to the vector summation of the measured force components corresponding to lines 1 and 2.

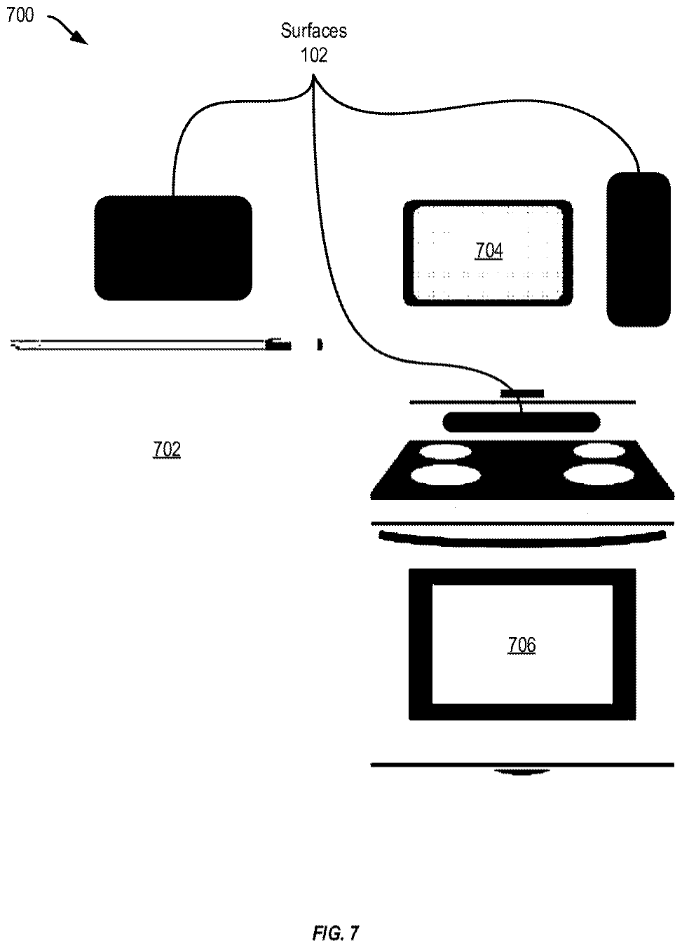

FIG. 7 shows examples of systems 700 for multi-directional haptic effects. In this example, three surfaces 102 are shown as parts of various kitchen appliances 702, 704, and 706. In this example, the various kitchen appliances include a refrigerator 702, a microwave 704, and an oven 706. However, the surfaces 102 may be part of any number of household appliances, such as a coffeemaker, fryer, grill, bread machine, convection oven, cooktop, espresso machine, hot plate, mixer, pressure cooker, rice cooker, waffle iron, laundry machine, or any other suitable appliance. Household appliances (e.g., refrigerator 702, microwave 704, and oven 706) may be stand-alone, haptically enabled devices that includes a computing device. In some examples, the kitchen appliances may be smart appliances. And in some examples, the kitchen appliances may be Internet of things (IoT) devices.

The refrigerator 702 includes a surface 102, which may be a touch screen. In some examples, the computing device may be communicatively coupled to or disposed within the refrigerator 702. The surface 102 may detect a user interaction. The refrigerator 702 may determine, based on the user interaction, a user input to perform task associated with a conventional refrigerator, such as adjusting a temperature setting for a refrigerated section or freezer, dispensing water or ice, setting a clock or timer, acknowledging a water filter notification, waking the screen, changing a screen saver, resetting the refrigerator 702 to one or more default settings, etc.

In one example, the computing device of the refrigerator 702 may determine a user input to the surface 102 is a predetermined or previously stored gesture (e.g., a swipe, drag-and drop, simulating drawing a letter, number, word, or phrase, or any other type of gesture). The computing device of the refrigerator 702 can determine whether such a gesture corresponds to a specific location, icon, graphical representation, button, etc. The refrigerator 702 may then determine the user interaction corresponds to a particular function. The computing device of the refrigerator 702 can also perform the function.

The refrigerator 702 may determine a haptic effect. The haptic effect may be based on the contact, gesture, location of the contact, function, or a combination of these. The computing device of the refrigerator 702 can generate one or more haptic drive signals to provide the haptic effect to the surface 102 according to any of the techniques discussed herein. In some examples, the computing device of the refrigerator 702 may only produce the haptic effect, only perform the function, or produce the haptic effect before, at the beginning of, throughout, substantially simultaneous to, or after performing the function.

In some examples, the refrigerator 702 may be an IoT device capable of network communications via the Internet. The refrigerator 702 may perform one or more operations using the Internet based on a user interaction. For example, the refrigerator 702 can execute one or more Internet-based applications to schedule a calendar event (e.g., a meal) with one or more users, looking-up an online recipe, synchronizing a grocery list in real-time, purchasing household items for delivery, setting an expiration date associate with contents within the refrigerator 702, creating a user profile, editing a to-do list, streaming video content, any combination of these, or any other suitable task. The refrigerator 702 may determine a different haptic effect for each of the user interactions. In some examples, the refrigerator 702 may access a local or remote look up table to determine a haptic effect associated with the one or more operations. In other examples, the refrigerator 702 may access a server or database that includes one or more user's preferences (e.g., a haptic profile) determine a haptic effect associated with the one or more operations. The refrigerator 702 may then retrieve the haptic effect and transmit a haptic signal configured to cause one or more resonant actuators to output the haptic effect at the surface 102.

In another example, the microwave 704 also includes a surface 102. The microwave 704 substantially similar features to those described above for the refrigerator 702. The microwave 704 may also perform tasks of conventional microwaves, such as adjusting a temperature setting for reheating food, defrosting foods, frequently used food settings (e.g., pizza, popcorn, baked potatoes, add 30 seconds, a quick timer, etc.), setting a clock or timer, acknowledging a notification, waking the screen, changing a screen saver, resetting the microwave 704 to one or more default settings, etc. And the microwave 704 may also execute Internet-based applications for scheduling a calendar event (e.g., a meal) with one or more users, looking online recipes, synchronizing a grocery list, purchasing household items for delivery, set a timer to being warming or defrosting food inside the microwave 704, etc.

The oven 706 includes a surface 102 (and can perform substantially similar to the refrigerator 702 and microwave 704). But in this example, the oven 706 performs tasks conventional to ovens. For example, a user input to the surface 102 can cause the oven 706 to adjust an oven or stove top temperature setting, a bake, broil or convection setting, adjust a fan speed, provide a self-cleaning notification. The oven 706 may be an IoT device that detect a user interaction with the surface 102 that indicates a user interaction, such as remotely setting a timer to begin cooking food inside oven 706.

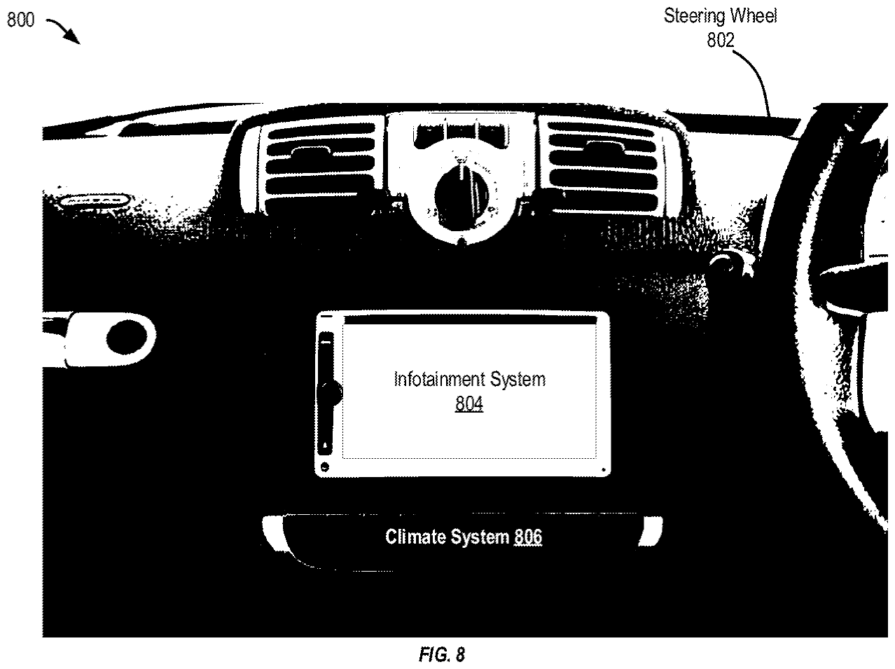

FIG. 8 shows other examples of systems 800 for multi-directional haptic effects, including a variety of non-touch-sensitive and touch-sensitive surfaces positioned in a vehicle to which multi-directional haptic effects can be output via one or more actuators. For instance, the steering wheel 802 includes a surface (e.g., surface 102) that is not touch-sensitive (e.g., it lacks touch-sensing capabilities and/or is passive). The steering wheel's surface may be formed from any suitable material, such as a plastic surface, a polymer, a metal alloy, etc. Other examples of non-touch-sensitive surfaces in a vehicle can include a display, gear shifter, dashboard, etc. FIG. 8 also depicts touch-sensitive surfaces, such as infotainment system 804 and climate system 806. For instance, the infotainment system 804 or the climate system 806 may include a touch-screen display or a touch-sensitive surface. The examples shown in FIG. 8 may employ any of the actuators, actuator configurations, systems, and techniques described elsewhere herein.

In one example, the infotainment system 804 and climate system 806 include touch displays that may include, or be coupled to, other components than those discussed above. In one example, the infotainment system 804 may include a navigation or GPS application. And advantageously, a user in contact with such a navigation or GPS application may enjoy omnidirectional haptic effects while in contact with the infotainment system 804. For example, the infotainment system 804 may output an omnidirectional haptic effect while a user pinches-to-zoom or slides a map of the navigation or GPS application across the infotainment system 804. In this case, regardless of the direction the user may suddenly choose, the infotainment system 804 may provide a consistent and strong haptic effect throughout the duration of the contact.

In some examples, the infotainment system 804 and climate system 806 include touch displays that may include, or be coupled to, other components than those discussed above. And one or more actuators (e.g., one or more resonant actuators 106) may also be coupled to other vehicle surfaces and controls, such as window up or down controls, car window locks, or power door locks, positioned on an automobile door, in order to provide haptic effects thereto. In some examples, such as in an instrument gauge, windscreen wipers, navigation, entertainment system on the dashboard, or any other suitable surface.

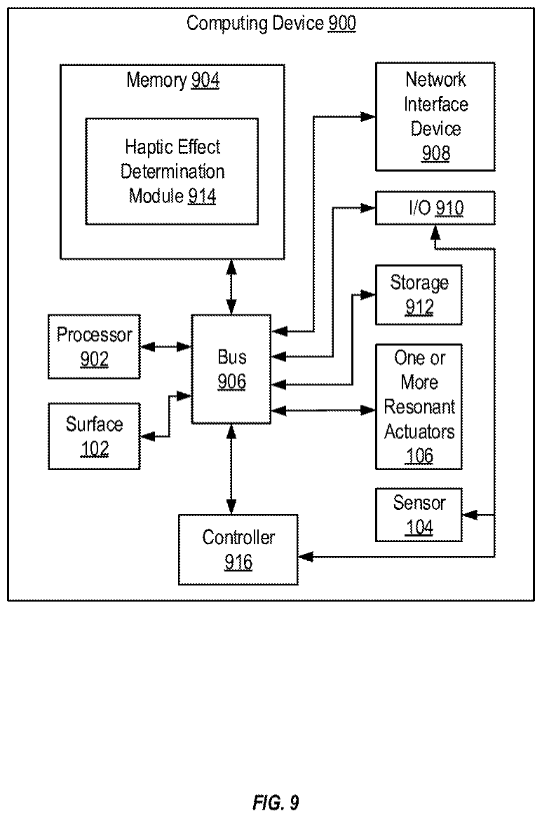

FIG. 9 shows an example of a computing device 900 suitable for use with any of the examples described above. The computing device 900 may be, for example, a personal computer, a mobile device (e.g., a smartphone), a head-mount display, a handheld device (e.g., a tablet), a camera, an automotive device (e.g., an infotainment system), a GPS, a video game device, an electronic control panel (e.g., for an automatic application, a home appliance, an heating or air conditioning system, etc.), or any other type of user device. In some examples, the computing device 900 can be any type of user interface device that can be used to interact with content (e.g., interact with a simulated reality environment, such as, an augmented or virtual reality environment).

The computing device 900 includes a processor 902 communicatively coupled to other hardware via a bus 906. A memory 904, which can be any suitable tangible (and non-transitory) computer-readable medium such as random access memory (RAM), read-only memory (ROM), erasable and electronically programmable read-only memory (EEPROMs), or the like, embodies program components that configure operation of the computing device 900. In the embodiment shown, computing device 900 further includes one or more network interface devices 908, input/output (I/O) interface components 910, and storage 912.

Network interface device 908 can represent one or more of any components that facilitate a network connection. Examples include, but are not limited to, wired interfaces such as Ethernet, USB, IEEE 1394, and/or wireless interfaces such as IEEE 802.11, Bluetooth, or radio interfaces for accessing cellular telephone networks (e.g., transceiver/antenna for accessing a CDMA, GSM, UMTS, or other mobile communications network).

I/O components 910 may be used to facilitate wired or wireless connections to devices such as one or more displays, game controllers, keyboards, mice, joysticks, cameras, buttons, speakers, microphones and/or other hardware used to input or output data. Storage 912 represents nonvolatile storage such as magnetic, optical, or other storage media included in computing device 900 or coupled to processor 902.

In some optional embodiments, the computing device 900 includes a surface 102 (e.g., a touch-sensitive surface) that can be communicatively connected to the bus 906. In some examples, the surface 102 may be configured to sense tactile input of a user in accordance with any of the techniques described herein. For example, surface 102 may include one or more sensors 104 that can be configured to detect a touch in a touch area (e.g., when an object contacts the surface 102) and transmits signals associated with the touch to the processor 902. In some examples, the surface 102 can include any suitable number, type, or arrangement of sensors such as, for example, resistive and/or capacitive sensors that can be embedded in surface 102 and used to determine the location of a touch and other information about the touch, such as pressure, speed, and/or direction. In one example, the computing device 900 can be a smartphone that includes the surface 102 (e.g., a touch-sensitive screen) and a touch sensor of the surface 102 can detect user input when a user of the smartphone touches the surface 102.

In some embodiments, the surface 102 is a touch screen that combines a touch-sensitive surface and a display device. The touch-sensitive surface may be overlaid on the display device, may be the display device exterior, or may be one or more layers of material above components of the display device. The display device may display a GUI that includes one or more virtual user interface components (e.g., buttons, knobs, sliders, etc.) and the touch-sensitive surface can allow interaction with the virtual user interface components.

In some embodiments, the surface 102 may be external to computing device 900 and be in communication with the computing device 900 (e.g., via wired interfaces such as Ethernet, USB, IEEE 1394, and/or wireless interfaces such as IEEE 802.11, Bluetooth, or radio interfaces). For example, the surface 102 may include a touch-sensitive surface, touch screen, non-display surface, projection surface and/or non-touch-sensitive surface that are external to, communicatively coupled with, and/or remote from the computing device 900 and configured to send and receive electrical signals to and from the processor 902.

Although one or more resonant actuators 106 is shown as a single actuator in FIG. 9, in some embodiments one or more resonant actuators 106 may include multiple actuators of the same or different types to produce different haptic effects. In some embodiments, the one or more resonant actuators 106 may be internal or external to computing device 900 and in communication with the computing device 900 (e.g., via wired interfaces such as Ethernet, USB, IEEE 1394, and/or wireless interfaces such as IEEE 802.11, Bluetooth, or radio interfaces). For example, the one or more resonant actuators 106 may be associated with (e.g., coupled to or within) the computing device 900 and configured to receive electrical signals (e.g., haptic drive signals) from the processor 902.

In some embodiments, the computing device 900 can include a user device that can be, for example, a mobile device (e.g., a smartphone or laptop computer), a wearable device (e.g., a head-mounted display, a ring, a hat, an armband, a bracelet, or a watch), a handheld device (e.g., a tablet, smartphone, e-reader, or video game controller), or any other type of user interface device. In some examples, the user device can be any type of user interface device that can be used to provide content (e.g., texts, images, sounds, videos, a virtual or augmented reality environment, etc.) to a user. In some examples, the user device can be any type of user interface device that can be used to interact with content (e.g., interact with a simulated reality environment, such as an augmented or virtual reality environment).

In some examples, processor 902 may execute program code or instructions stored in memory 904 (e.g., haptic effect determination module 914) to detect an event, determine a haptic effect based on the event, and operate the one or more resonant actuators 106 to generate the haptic effect. One example of such an event can include a user interaction with the surface 102. When a user interacts with surface 102, processor 902 may receive location or force signals from surface 102 and/or sensor 104. In one non-limiting example, processor 902 may then execute program code or instructions to calculate an amount of force applied to the surface 102. In response to determining the location and/or amount of pressure associated with a user interaction, the processor 902 may execute the haptic effect determination module 914 to determine a haptic effect associated with the signal(s) from the surface 102 and/or sensor 104 based on a user interaction that corresponds to a specific haptic effect. After such a determination is made, processor 902 may generate at least one haptic drive signal that can be sent to the one or more resonant actuators 106 to generate and output a haptic effect, e.g., a multi-directional haptic effect, associated with the user interaction. The haptic effect can include a vibrotactile effect, friction effect, or any other haptic effect discussed herein.

In some examples, a controller 916 may adjust, alter, or otherwise modify the haptic drive signal sent to the one or more resonant actuators 106 using any of the techniques described herein. The controller 916 may adjust the haptic drive signal to preserve the fidelity of the multi-directional haptic effect. Although the controller 916 is depicted in FIG. 9 as separate from the processor 902, in other examples the functionality of the controller 916 may be alternatively implemented by the processor 902.

One or more resonant actuators 106 may be configured to output a haptic track or haptic effect to the surface 102 in response to one or more haptic drive signals. For example, the one or more resonant actuators 106 can output a haptic track in response to a haptic drive signal from a processor 902 of the computing device 900. In some examples, the one or more resonant actuators 106 are configured to output a haptic track comprising, for example, a vibration, a change in perceived coefficient of friction, a simulated texture, an electrotactile effect, a bump, a pop, a click, or heat. Further, some haptic tracks may use a plurality of the one or more resonant actuators 106 of the same or different types in sequence and/or in concert.

In some examples, a specific user interaction may have one or more associated haptic tracks. For example, correspondences between one or more user interactions and one or more haptic tracks may be stored in lookup tables or databases. Each haptic track may include haptic information and be associated with one or more user inputs, such as an amount of pressure, a location of the user input, a pattern of inputs, etc. in the applied force(s) associated with the user interaction(s), and each interaction may be associated with one or more haptic tracks. A haptic track can include a haptic effect (e.g., a vibration, a friction effect, a thermal effect) or a series of haptic effects that correspond to the user interaction. For example, a user interaction associated with a press and hold event may have one haptic track (e.g., a user input of a thumbprint may have an vibrotactile haptic track), while a user input of a finger press and patterned movement may have a different haptic track (e.g., a friction haptic track) or a combination of haptic tracks.

It should be appreciated that while haptic tracks above have been described as including haptic information about multiple haptic effects, a haptic track may include only a single haptic effect, or may only reference haptic effects that are stored at another location, such as within a haptic library or stored remotely at a server.

While FIG. 9 shows computing device 900 including the surface 102, the computing device 900 may be communicatively coupled with a remote haptically-enabled surface 102 (e.g., a smartphone, tablet, etc.). In some examples, the surface 102 can include any suitable number, type, or arrangement of touch sensors (e.g., sensors 104) such as, for example, resistive and/or capacitive sensors that can be embedded in surface 102 and used to determine the location of a touch and other information about the touch, such as pressure, speed, and/or direction. In one example, the computing device 900 can be a smartphone that includes the surface 102 (e.g., a touch screen), and a touch sensor of the surface 102 can detect user input when a user of the smartphone touches the surface 102.

It should be appreciated that computing device 900 may also include additional processors, additional storage, and a computer-readable medium (not shown). The processor(s) 902 may execute additional computer-executable program instructions stored in memory 904. Such processors may include a microprocessor, digital signal processor, application-specific integrated circuit, field programmable gate arrays, programmable interrupt controllers, programmable logic devices, programmable read-only memories, electronically programmable read-only memories, or other similar devices.

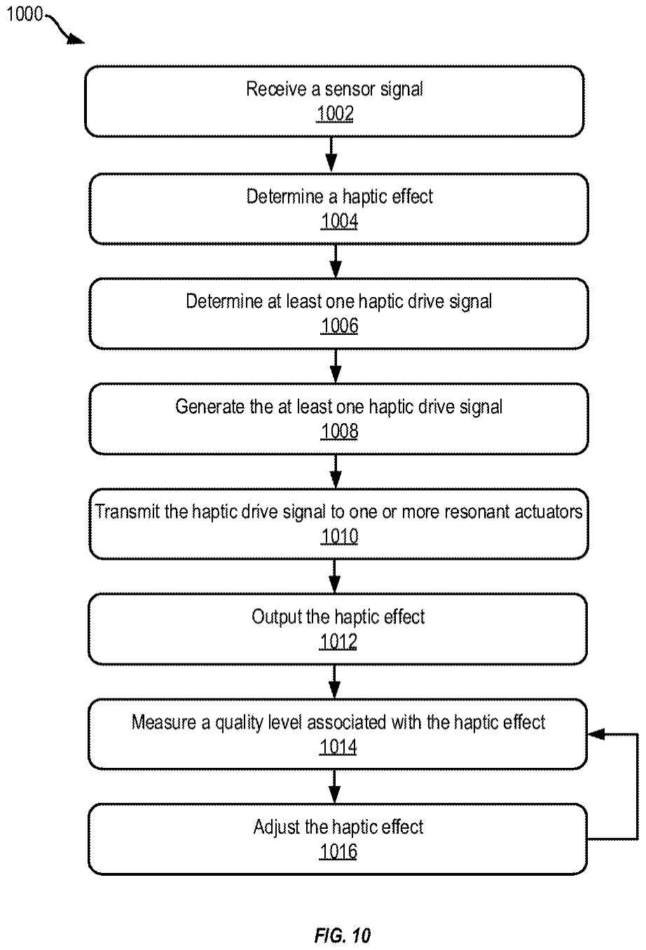

FIG. 10 shows an example method 1000 for providing multi-directional haptic effects. In some examples, the steps shown in FIG. 10 may be implemented in program code that is executable by a processor, for example, the processor 902 in the computing device 900 or a processor in a general-purpose computer, a mobile device, or a server. In some embodiments, one or more steps shown in FIG. 10 may be omitted or performed in a different order. Similarly, additional steps not shown in FIG. 10 may also be performed. For illustrative purposes, the steps of the method 1000 are described below with reference to components described above with regard to the computing device 900 shown in FIG. 9, but any suitable system according to this disclosure may be employed.

The method 1000 begins at block 1002, when the computing device 900 or surface 102 receives a sensor signal, e.g., from the surface 102 or sensor 104, according to any of the techniques discussed herein. In some examples, the sensor signal may be detected in response to an event occurring within a virtual environment. In some examples, the virtual environment may include a video game, and the event may include an interaction within the game. For instance, sensor signal may indicate a user interaction with a virtual object (e.g., contact with a virtual character in an augmented reality application); manipulation of a virtual object (e.g., moving or bouncing of a virtual object); a change in scale, location, orientation, color, or other characteristic of a virtual object; a virtual explosion, gunshot, and/or collision; an interaction between game characters; advancing to a new level; losing a life and/or the death of a virtual character; and/or traversing particular virtual terrain; etc.

In some examples, the sensor signal may be associated with an event, e.g., an event occurring in real space. For example, a sensor signal may include information associated with an event in real space. In some examples, such an event may include an interaction with the computing device 900 (e.g., a gesture, multi-touch input, swipe, movement, etc. along surface 102); an interaction with a virtual object projected via a projector onto a surface 102; a change in status or location of the computing device 900; receiving data; sending data; and/or movement of a user's body part (e.g., an arm, leg, or a prosthetic limb).

In some examples, the sensor signal may be detected based on a user interaction with the surface 102. For example, a user interaction may include a gestural interaction. In some examples, gestural interactions may include a user scroll through a GUI displayed on the surface 102. In another example, a gestural interaction may include a user swiping his or her finger in one or more directions along the surface 102 (e.g., swiping to the left/right or up/down with respect to the user). In some examples, a user interaction may include any number of gestures such as a four finger pinch, wherein using four fingers the user makes a pinching gesture, a tap, or a hand wave.

At block 1004, the computing device 900 determines a haptic effect based on the sensor signal and/or event. In some examples, the processor 902 may execute the haptic effect determination module 914 to determine the haptic effect. For instance, the processor 902 may determine an event based on sensor data derived from the sensor signal. In this example, the processor 902 may determine the haptic effect based on the event.

In one example, the processor 902 may determine a haptic effect based on a user interaction with a specific application. For instance, the processor 902 may determine a sensor signal indicates a user interaction with a GPS map displayed on the surface 102. In response to the determination, the processor 902 may determine a haptic effect based on location information associated with the user interaction, a terrain displayed on the GPS map, an amount of pressure associated with the user interaction, a movement (e.g., direction, velocity, acceleration, distance, etc.) associated with the user interaction. And in some examples, the processor 902 may determine a timing associate with the haptic effect. For example, the processor 902 may determine the haptic effect is a multi-directional haptic effect that may be output concurrently with the user interaction throughout a duration of a user contact with the surface 102. The haptic effect may be determined using any technique or combination of techniques discussed herein.

At block 1006, the computing device 900 determines at least one haptic drive signal. In some examples, the processor 902 may execute the haptic effect determination module 914, which may include instructions to determine at least one haptic drive signal based on the haptic effect. In other examples, the processor 902 may determine at least one haptic drive signals based on the communicatively coupled to one or more resonant actuators 106. For example, the processor 902 may determine the at least one haptic drive signals based on a type of the one or more resonant actuators 106 (e.g., a resonant actuator, such as a CRA or LRA), a number of the one or more resonant actuators 106, an arrangement of one or more resonant actuators 106 (e.g., an angular offset), a characteristic of the haptic effect, or any combination of these. The at least one haptic drive signal may be determined using any technique or combination of techniques discussed herein, and may have any of the characteristics discussed herein.

At block 1008, the computing device 900 generates the at least one haptic drive signal. In some examples, the processor 902 may generate the at least one haptic drive signal based on information received from the haptic effect determination module 914. The information received by the processor may include instructions to generate at least one haptic drive signal based on the haptic effect determined using any technique or combination of techniques discussed herein. In other examples, the processor 902 may generate the at least one haptic drive signal based on communicatively coupled one or more resonant actuators 106. For example, the processor 902 may generate the at least one haptic drive signal based on a number or a type of the one or more resonant actuators 106, an arrangement of one or more resonant actuators 106, a characteristic of the haptic effect, or any combination of these. The at least one haptic drive signal may be generated using any technique or combination of techniques discussed herein, and may have any of the characteristics discussed herein.

At block 1010, the computing device 900 transmits the at least one haptic drive signal to the one or more resonant actuators 106. The at least one haptic drive signal is an electrical signal having specific characteristics configured to yield the determined haptic effect. In some examples, the at least one haptic drive signal causes a mass (e.g., mass 206) to vibrate at its resonant frequency and accelerate between positionally-opposing magnets in a substantially linear path. In some examples, the at least one haptic drive signal may include more than one electrical signal. For example, the at least one haptic drive signal may include two or more phase-shifted versions of the same haptic drive signal that is configured to drive two or more of the one or more resonant actuators 106. In some examples, phase-shifted haptic drive signals may cause two or more actuators (e.g., two or more resonant actuators 106) to produce a haptic effect that is output in a substantially circular path.

At block 1012, the one or more resonant actuators 106 outputs the haptic effect, which may be a multi-directional haptic effect, based on the at least one haptic drive signal received from the computing device 900. Multi-directional haptic effects may be advantageous because they provide substantially identical haptic sensations in all directions. For instance, a user that is in contact with a surface (e.g., surface 102) may move unpredictably, along the surface in any direction, and the multi-directional haptic effect may provide consistent haptic feedback to the user irrespective of the directionality of movement along the surface. And the fidelity of the haptic feedback may be preserved with the delivery of precise haptic effects throughout such a movement, providing a more enjoyable user experience.

Blocks 1014 and 1016 may be optional steps. At block 1014, the computing device 900 measures a quality level of the haptic effect. For example, the sensor 104 can detect one or more characteristics of the haptic effect output by the one or more resonant actuators 106 and transmits sensor signals representative of the detected characteristics. The computing device 900 can then determine the quality level associated with the haptic effect based on the sensor signals. For example, the computing device 900 may determine that a periodicity associated with sensor data obtained during the haptic effect is insufficiently small and causes haptic confusion.

At block 1016, the computing device 900 alters the haptic effect. For example, the computing device 900 may determine when a periodicity of a haptic effect with a particular phase-shifted haptic drive signal falls below a predetermined threshold at block 1014. In response, the computing device 900 may employ controller 916 to adjust the phase shift between two or more resonant actuators 106. And in this example, the controller 916 may continuously monitor the haptic effect via sensor data obtained from sensor 104 to ensure an adjustment that increases the phase shift between two or more resonant actuators 106 satisfies a predetermined criterion (e.g., the above-mentioned threshold periodicity). In some examples, the method 1000 may continue by returning to block 1014, continuously monitoring the haptic effect throughout the duration of the haptic effect. Further, the computing device 900 may alter the haptic effect at block 1014, iteratively, throughout a portion of or duration of the haptic effect.

Although the above operations are described sequentially, many of the operations can be performed in parallel or concurrently. In addition, the order of the operations may be rearranged. A process may have additional steps not included in the FIG. 10. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

### General Considerations

Certain aspects and features of the present disclosure involve systems capable of providing multi-directional or omnidirectional haptic effects at a surface that a user is in contact with. These systems can provide haptic effects, for example, by actuating CRAs or selectively actuating LRAs that are coupled to the surface.

In one example, a user may interact with (e.g., contact) a surface of a home appliance. The home appliance may be configured to detect the user interaction that provides a user input via a GUI, menu, or other user interface device (e.g., a button). And in response, the home appliance may output a selected, multi-directional haptic effect during the contact. The user may stay in contact with the surface of the home appliance while moving a finger across the screen (e.g., a user performing a drag-and-drop, pinch-to-zoom, or multi-level menu operation). Advantageously, a multi-directional haptic effect may be perceptible with substantially the same strength and consistency at any location along the surface during such a finger movement.

In another example, a vehicle may have a GPS system configured to receive user inputs via a GUI. A user in contact with the GUI may be searching for a location. And the user may pinches-to-zoom or slides a map of the GPS system. Advantageously, the user may have a more enjoyable experience with the GPS system with an omnidirectional haptic effect. Since the user does not know the location of his/her potential location, it would be advantageous to ensure the user perceived consistent haptic effects while manipulating the map of the GPS system. Thus, the omnidirectional haptic effects discussed herein may provide an improved user experience because regardless of any potential spontaneous change direction the user may perform, the GPS system may provide the solid and/or intense haptic feedback that spans substantially the entire surface for the full length of the user's contact.

Some other haptic output devices, such as a single LRA coupled to a similar surface may provide weak haptic effects during a similar movement in a direction corresponding to a length of the single LRA. But the multi-directional haptic effects described herein provide greater strength and consistency for the duration of the multi-directional haptic effect, with a magnitude that is demonstrably consistent at various locations of the surface.

The methods, devices, and systems discussed above are examples. Various configurations may omit, substitute, or add various procedures or components. For example, in alternative configurations, the methods may be performed in a different order. In another example, the methods may be performed with fewer steps, more steps, or in combination. In addition, certain configurations may be combined in various configurations. As technology evolves, many of the elements are examples and do not limit the scope of the disclosure or claims.

While some examples of methods, devices, and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

That which is claimed is:

1. A system comprising:
one or more resonant actuators coupled to a surface, the one or more resonant actuators configured to generate a haptic effect comprising vibrations in a plurality of nonparallel directions, the haptic effect configured to displace the surface, and the vibrations being within a two-dimensional plane that is substantially parallel to the surface;
a processor in communication with the one or more resonant actuators; and
a non-transitory computer-readable medium comprising instructions that are executable by the processor to cause the processor to:
detect an event;
generate at least one haptic drive signal based on the event; and
transmit the at least one haptic drive signal to the one or more resonant actuators, the one or more resonant actuators further configured to receive the at least one haptic drive signal and responsively output the haptic effect.

2. The system of claim 1, the one or more resonant actuators further configured to output the haptic effect with a substantially equal amount of force in at least two of the plurality of nonparallel directions within the two-dimensional plane.

3. The system of claim 1, the surface comprising a touch screen.

4. The system of claim 1, the surface comprising a touch-sensitive surface of an automobile or a home appliance.

5. The system of claim 1, at least one of the one or more resonant actuators comprising a curved resonant actuator.

6. The system of claim 5, the curved resonant actuator comprising a guide that defines a nonlinear path along which a mass reciprocates to generate the vibrations, and the nonlinear path comprising at least one arcuate section.

7. The system of claim 1, the one or more resonant actuators comprising a first resonant actuator and a second resonant actuator, wherein the first resonant actuator and the second resonant actuator are coupled to the surface in different orientations with respect to each other.

8. The system of claim 7, the first resonant actuator and the second resonant actuator being configured to be independently controlled by the processor.

9. The system of claim 7, the at least one haptic drive signal comprising a first haptic drive signal and a second haptic drive signal, the first haptic drive signal configured to cause the first resonant actuator to output a first component of the haptic effect, the second haptic drive signal configured to cause the second resonant actuator to output a second component of the haptic effect, and the first haptic drive signal and the second haptic drive signal being transmitted concurrently to the first resonant actuator and the second resonant actuator.

10. The system of claim 9, the second haptic drive signal being a time-delayed version of the first haptic drive signal.

11. The system of claim 9, the second haptic drive signal being a phase-shifted version of the first haptic drive signal.

12. The system of claim 1, further comprising a sensor configured to detect a characteristic of the haptic effect and transmit a sensor signal associated with the characteristic, and the non-transitory computer-readable medium further comprising instructions that are executable by the processor to cause the processor to:
receive the sensor signal from the sensor;
determine a control signal based on the characteristic of the haptic effect detected by the sensor; and
transmit the control signal, the control signal configured to adjust the haptic effect.

13. The system of claim 12, further comprising a controller configured to receive the control signal and adjust the haptic effect by:
modifying a phase shift associated with the at least one haptic drive signal.

14. The system of claim 13, the controller being a closed-loop controller configured to continuously adjust the haptic effect based on a predetermined quality level associated with the haptic effect.

15. A method for multi-directional haptic effects comprising:
detecting, by a processor, an event;
generating, by the processor, at least one haptic drive signal based on the event; and
transmitting, by the processor, the at least one haptic drive signal to one or more resonant actuators, the one or more resonant actuators configured to receive the at least one haptic drive signal and responsively output a haptic effect comprising vibrations in a plurality of nonparallel directions, the haptic effect configured to displace a surface, and the vibrations being within a two-dimensional plane that is substantially parallel to the surface.

16. The method of claim 15, the one or more resonant actuators further configured to output the haptic effect with a substantially equal amount of force in at least two of the plurality of nonparallel directions within the two-dimensional plane.

17. The method of claim 15, at least one of the one or more resonant actuators comprising a curved resonant actuator.

18. The method of claim 15, the at least one haptic drive signal comprising a first haptic drive signal and a second haptic drive signal, the first haptic drive signal configured to cause a first resonant actuator of the one or more resonant actuators to output a first component of the haptic effect, the second haptic drive signal configured to cause a second resonant actuator of the one or more resonant actuators to output a second component of the haptic effect, and the first haptic drive signal and the second haptic drive signal are transmitted concurrently to the first resonant actuator and the second resonant actuator.

19. The method of claim 18, the second haptic drive signal being a phase-shifted version of the first haptic drive signal.

20. The method of claim 15, further comprising:
receiving, by the processor, a sensor signal from a sensor, the sensor signal indicating a characteristic of the haptic effect;
determining, by the processor, a control signal based on the characteristic of the haptic effect detected by the sensor; and
transmitting, by the processor, the control signal, the control signal configured to adjust the haptic effect.
